(19) United States
(12) Patent Application Publication
(10) Pub. No.: US 2004/0100154 A1
(43) Pub. Date: May 27, 2004

(54) Concentrated winding electric motor having optimized winding cooling and slot fill

(76) Inventors: Khwaja M. Rahman, Torrance, CA (US); Steven E. Schulz, Torrance, CA (US)

Correspondence Address: CHRISTOPHER DEVRIES, General Motors Corporation, Legal Staff, Mail Code 482-C23-B21, P.O. Box 300, Detroit, MI, 48265-3000, US

(21) Appl. No.: 10/304,337

(22) Filed: Nov. 26, 2002

(51) Int. Cl. H02K 9/00; H02K 9/20

(52) U.S. Cl. 310/54; 310/58; 310/52

(57) ABSTRACT

Optimized winding cooling and slot fill of a concentrated winding electric motor provides a means to maximize a motor's winding cooling without decreasing its slot fill factor, thereby improving the motor's torque density and efficiency. The motor uses a stator with trapezoidal-shaped stator teeth separated by rectangular stator slots. Windings placed around each stator teeth partially fill the stator slots, leaving rectangular spaces between each group of windings. Cooling tubes are placed in these leftover spaces. The cooling tubes' rectangular geometry allows the tubes to contact every outer turn of the adjacent stator windings, providing efficient thermal conduction between the cooling tubes and windings. Because the cooling tubes are placed in a normally unused portion of the stator, they do not decrease the motor's slot fill factor. The motor's efficient cooling allows it to run at high current, thus improving the motor's torque density and efficiency.

### TECHNICAL FIELD

This invention relates generally to a concentrated winding electric motor, and more specifically to optimized winding cooling and slot fill of a concentrated winding electric motor having a high fill factor and a high torque density.

### BACKGROUND OF THE INVENTION

There are two primary changes that can be made to the stator of an electric motor that will increase the torque density or the torque per unit weight of the motor. One primary change is to increase the number of stator windings. The greater the slot fill factor, or percent of the motor's volume that is occupied by windings, the greater the motor's torque will be. Increasing a motor's slot fill factor will also increase the motor's efficiency. This method for improving torque, however, is physically limited by the shape and size of the stator. The other primary change employed to increase the motor's torque density involves increasing the amount of current that flows through the stator windings. This method is also limited by physical problems. Increases in current flowing through the stator windings cause increases in motor heating due to resistive or ohmic heating.

Cooling methods exist to help keep the stator windings at an acceptable operating temperature when an increased amount of current flows through the stator windings. These methods include cooling jackets that surround the electric motor, cooling tubes in contact with the windings, and even immersing the windings in coolant. Cooling jackets around the outside of the electric motor are unable to efficiently cool the windings, which are too deep within the motor to be effectively cooled by a coolant circulating within the jacket. Cooling tubes may do a better job of cooling the windings, but they involve reshaping the stator and decreasing the number of windings in order to fit the cooling tubes inside the motor. Thus, the existing cooling tube designs decrease the slot fill factor and sacrifice torque density in order to keep the windings cooled to an optimal temperature. Additionally, existing cooling tube designs generally will not contact each winding of the motor, thus leading to hot spots and non-uniform cooling. The same is true for direct immersion of the windings in coolant; space has to be made for the coolant by eliminating some of the windings, thus lowering the motor's torque density.

Accordingly, a need exists for optimized winding cooling and slot fill of a concentrated winding electric motor, so that winding cooling is maximized while at the same time space used for cooling in the stator is minimized, allowing for the maximum slot fill factor and thus maximizing the motor's torque density and efficiency.

### BRIEF DESCRIPTION OF THE DRAWINGS

The invention and method of application will be understood after review of the following description considered together with the drawings in which:

FIG. 1 illustrates, in cross section, a motor 10 in accordance with one embodiment of the invention;

FIG. 2 illustrates, in cross section, a portion of a stator in accordance with one embodiment of the invention; and

FIGS. 3 and 4 illustrate, in perspective and cross section, respectively, a cooling tube 18 in accordance with one embodiment of the invention.

### DESCRIPTION OF THE PREFERRED EMBODIMENT

A concentrated winding motor employing optimized winding cooling and slot fill, in accordance with an embodiment of the invention, utilizes optimized cooling tubes that allow for efficient cooling without decreasing slot fill factor. Concentrated winding electric motors utilizing such optimized winding cooling, in accordance with the invention, find application, for example, in hybrid motor vehicles. It is not intended, however, to limit the scope or application of the invention to any particular application.

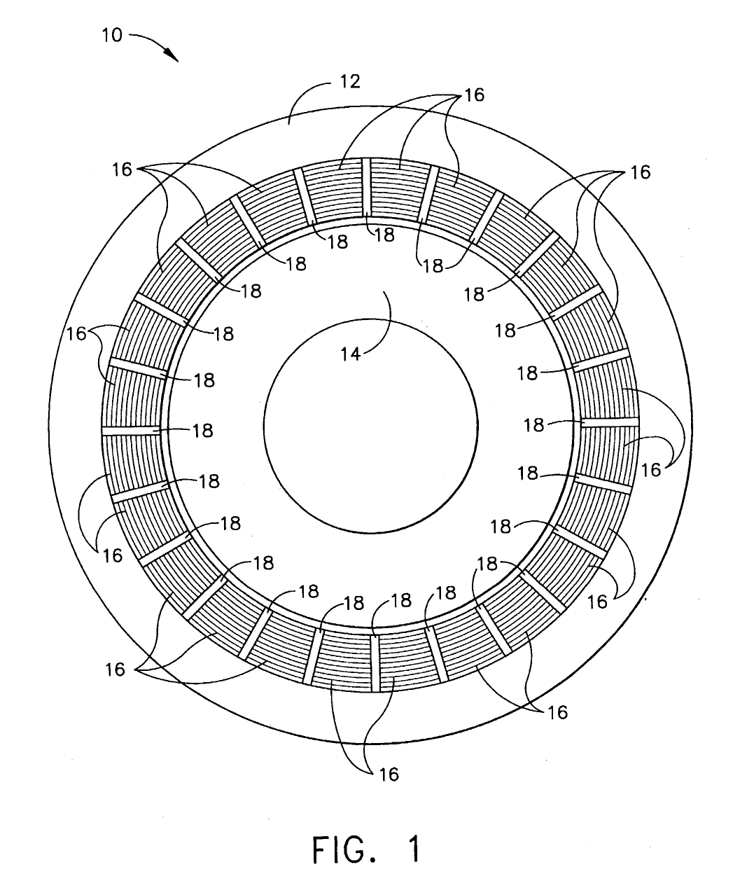

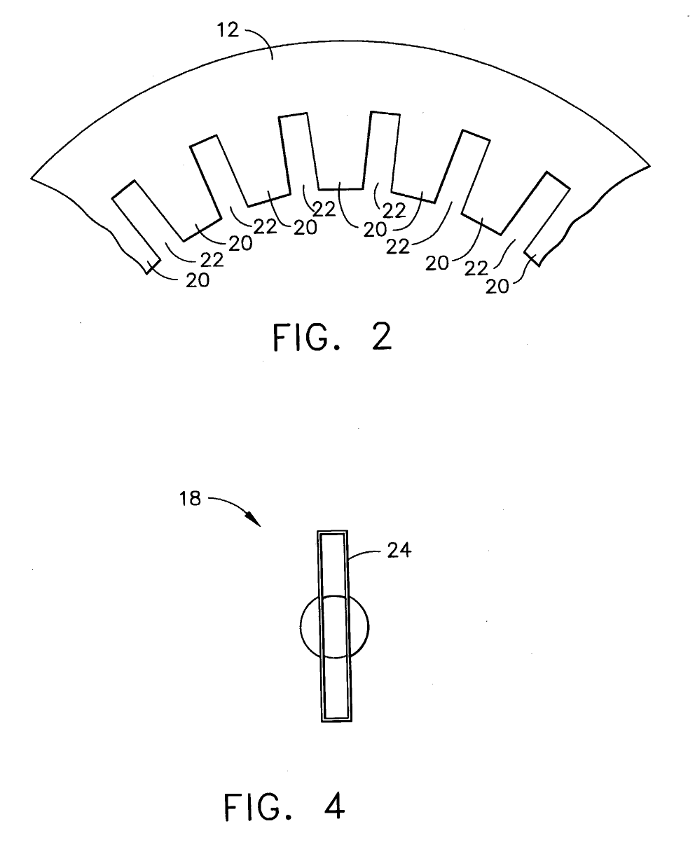

FIG. 1 schematically illustrates an electric motor 10 for use in a hybrid motor vehicle. FIG. 2 illustrates a portion of a stator 12 for use in electric motor 10. Electric motor 10 may be, for example, a switched reluctance motor or the like. Electric motor 10 consists of a rotor 14 that rotates within a stator 12. The stator has several stator teeth 20, each of which is separated by a stator slot 22. In accordance with the illustrated embodiment, twenty-four stator teeth are used in the motor, although a greater or lesser number of stator teeth can be used depending on the design of the motor. Electrically conductive winding coils 16, preferably copper in composition and rectangular in cross section, surround stator teeth 20 and partially fill stator slots 22. Winding coils 16 may be, for example, edge wound or the like, although in a preferred embodiment of the invention, the winding coils are edge wound. Located in the space remaining in each stator slot, and in contact with the adjacent windings, are cooling tubes 18. Cooling tubes 18 are preferably constructed of a material that has a high electrical resistivity and a low magnetic permeability such as, for example, non-magnetic stainless steel, cupra-nickel, or the like. The use of material that has a high electrical resistivity and a low magnetic permeability minimizes eddy current loss in the motor. The terms “high electrical resistivity” and “low magnetic permeability” are terms known to those of skill in the art of electric motor construction, and those of such skill will know how to select materials meeting these terms as needed for use in a particular application. Any air voids between the winding coils and the cooling tubes are filled with a thermally conductive adhesive material (not illustrated to avoid confusion in the drawings) that adhesively bonds the motor components and aids in conducting heat from the coils to the cooling tubes. This material may be, for example, thermally conductive bonding epoxy, or the like. The material provides for an effective transfer of heat from the winding coils to cooling tubes, as well as holding the cooling tubes in place.

Again with reference to FIG. 2, stator 12 is designed so that stator teeth 20 are trapezoidal in cross section, that is, the stator teeth are narrower in cross section closer to rotor 14 and wider further away from the rotor. This stator teeth geometry improves torque density over stator teeth that has a constant width by reducing the reluctance of the magnetic path in the stator teeth. In addition, the trapezoidal stator teeth shape results in a rectangular cross section of slots 22, which reduces the complexity of the motor assembly as explained below. Slots 22 are designed so that each slot openings is wider than the widths of two winding coils; that is, the width of the windings from two adjacent coils. This stator slot width allows a pre-wound winding coil to be simply inserted around each of the stator teeth without interference during assembly. After a winding coil is inserted around each of the stator teeth, an unoccupied rectangular portion of each stator slot remains. A cooling tube is then placed in the unoccupied portion of each stator slot, preferably in physical and thermal contact with the adjacent winding coils. The number of stator slots, and thus the number of winding coils and cooling tubes, is dependent on the number of stator teeth. In accordance with the illustrated embodiment, 24 stator slots, and thus 24 winding coils and 23 cooling tubes, are used in the motor, although a greater or lesser number of slots, cooling tubes, or winding coils can be used. The unoccupied portions of the stator slots, which allow for easy assemblage of the winding coils on the stator teeth, would go unused if not for the cooling tubes. Thus, the cooling tubes, due to their placement in an otherwise unused part of the stator, allow for efficient cooling without decreasing the motor's slot fill factor.

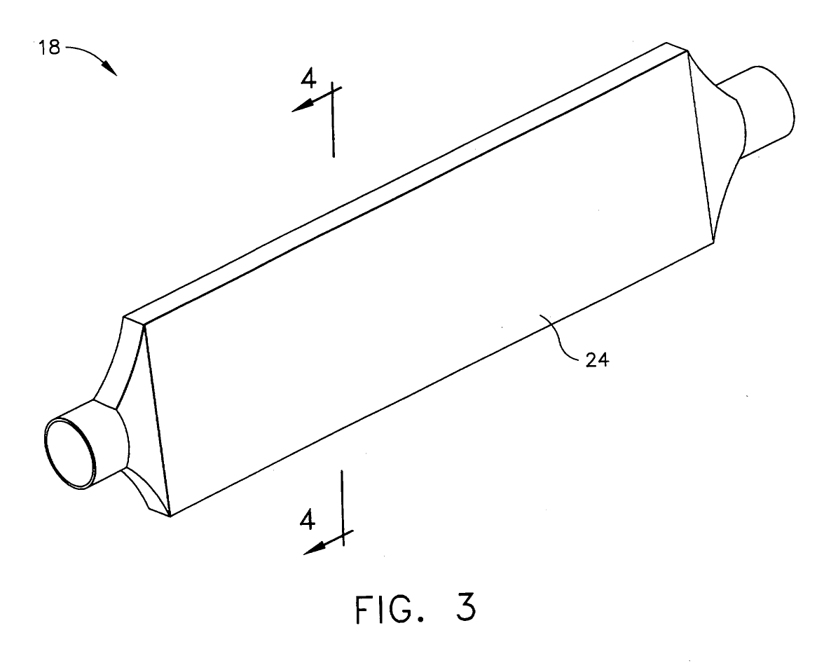

FIGS. 3 and 4 schematically illustrate the shape of a cooling tube in accordance with one embodiment of the invention. Cooling tube 18 is rectangular in cross section for the portion of the tube that is inserted into slot 22, and is circular in cross section at both ends of the tube, with a short section at both ends of the tube where the tube transitions from circular to rectangular. The cooling tubes are designed to allow coolant to flow freely from one end of the tube to the other. The circular ends of the cooling tubes are configured for sealing to inlet and outlet manifolds that pump coolant through the cooling tubes. Such manifolds are well known and are not illustrated. A coating 24 of an electrically insulating material covers the rectangular portion of the cooling tube and prevents any shorting around the windings, either coil to coil or turn to turn. This coating may be, for example, electrically insulating tape wrapped around the rectangular portion of the tube, or the like. The cooling tubes are also electrically insulated from the manifolds to reduce induced current circulation around consecutive cooling tubes. This can be done, for example, by utilizing plastic seals and O-rings on the manifolds, thus providing electrical insulation as well as creating a leak-proof seal. Alternatively, a number of methods exist to electrically insulate the cooling tubes from the windings and the manifold, for example, coating the ends of the cooling tubes with an electrically insulating material such as insulating varnish, or the like. The end bells of the motor can be modified to provide or accommodate the manifolds. The rectangular cross-sectional portion of the cooling tube, combined with the stator geometry that provides for a rectangular cross section of slot 22, allows the cooling tube to be in contact with every outer turn of the adjacent winding coils. For an edge wound coil, the rectangular portion of the cooling tube is in contact with every turn of the winding. The cooling tubes are thus able to achieve a very effective thermal transfer between the cooling tubes and the winding coils.

Thus it is apparent that there has been provided, in accordance with the invention, an optimized winding cooling and slot fill of a concentrated winding electric motor that meets the needs set forth above. The motor provides efficient winding cooling and a maximized slot fill factor, thus improving the motor's efficiency and allowing the motor to run at high current, thereby increasing the motor's torque density. Although the invention has been described and illustrated with reference to specific embodiments thereof, it is not intended that the invention be limited to such illustrative embodiments. For example, the winding coils need not be wound with rectangular wires and need not be edge wound. The cooling tubes may be made of low conductivity, low magnetic permeability materials other than those enumerated, with the material selected in known manner for the particular application. Those of skill in the art will recognize that many variations and modifications of such embodiments are possible without departing from the spirit of the invention. Accordingly, it is intended to be included within the invention all such variations and modifications as fall within the scope of the appended claims.

1. An electric motor comprising:
a stator having a plurality of stator teeth, each of the stator teeth having a trapezoidal cross section;
each of the stator teeth spaced apart from an adjacent one of the stator teeth by a stator slot;
a winding coil surrounding each of the stator teeth and occupying a portion of the stator slot and leaving an unoccupied remainder portion of the stator slot; and
a cooling tube positioned in the unoccupied remainder portion of each stator slot.

2. The electric motor of claim 1 wherein the stator slot has a rectangular cross section.

3. The electric motor of claim 1 wherein the cooling tube comprises an elongated tube having a flat, rectangular cross section.

4. The electric motor of claim 3 wherein the cooling tube further comprises an end portion having a circular cross section adapted for connection to a fluid manifold.

5. The electric motor of claim 3 further comprising electrical insulation on the cooling tube.

6. The electric motor of claim 3 wherein the cooling tube comprises a material having a high electrical resistance and a low magnetic permeability.

7. The electrical motor of claim 6 wherein the cooling tube comprises non-magnetic stainless steel.

8. The electric motor of claim 1 wherein the winding coil comprises an edge wound winding coil.

9. The electric motor of claim 8 wherein the winding coil comprises a winding of a conductor having a rectangular cross section.

10. The electric motor of claim 8 wherein the cooling tube contacts each winding of the edge wound coil.

11. The electric motor of claim 10 further comprising a thermally conductive adhesive filling voids between the cooling tube and the winding coil.

12. The electric motor of claim 1 wherein the winding coil comprises a winding of a conductor having a rectangular cross section.

13. An electric motor comprising:
a stator having a plurality of stator teeth, each of the stator teeth having a trapezoidal cross section;
a plurality of pre-wound, edge wound winding coils, one of the plurality of pre-wound, edge wound winding coils positioned to surround each of the stator teeth, each of the plurality of pre-wound, edge wound winding coils having a thickness;
a plurality of cooling tubes, one of the plurality of cooling tubes positioned between each of adjacent ones of the plurality of pre-wound winding coils, each of the plurality of cooling tubes having a thickness; and
a plurality of stator slots, each of the plurality of stator slots having a rectangular cross section and separating adjacent ones of the plurality of stator teeth, each of the plurality of stator slots having a width approximating the combined thickness of the pre-wound winding coils surrounding adjacent ones of the stator teeth plus the thickness of a cooling tube.

14. The electric motor of claim 13 wherein the plurality of cooling tubes comprises a plurality of non-magnetic stainless steel cooling tubes.

15. The electric motor of claim 13 further comprising a thermally conductive adhesive between the each of the plurality of cooling tubes and the adjacent ones of the plurality of pre-wound winding coils.

16. The electric motor of claim 13 wherein each of the plurality of cooling tubes comprises a flat portion having a rectangular cross section.

17. The electric motor of claim 16 further comprising a fluid manifold coupled to each of the plurality of cooling tubes.

18. The electric motor of claim 13 wherein each of the plurality of pre-wound, edge wound winding coils is in thermal contact with one of the plurality of cooling tubes.

19. The electric motor of claim 13 wherein the plurality of pre-wound, edge wound winding coils comprise edge wound winding coils of conductors having a rectangular cross section. 20. The electric motor of claim 13 further comprising an electrical insulating material on the plurality of cooling tubes.
